(19) United States
(12) Patent Application Publication
(10) Pub. No.: US 2010/0002601 A1
(43) Pub. Date: Jan. 7, 2010

(54) METHODS FOR HARDWARE REDUCTION AND OVERALL PERFORMANCE IMPROVEMENT IN COMMUNICATION SYSTEM

(75) Inventors: Salvatore Carta, Cagliari (IT); Paolo Meloni, Loceri (IT); Giovanni De Micheli, Lausanne (IT); Luigi Raffo, Cagliari (IT)

Correspondence Address: DLA PIPER LLP (US);ATTN: PATENT GROUP, P.O. Box 2758, Reston, VA, 20195, US

(73) Assignee: ECOLE POLYTECHNIQUE FEDERALE DE LAUSANNE (EPFL), Lausanne (CH)

(21) Appl. No.: 12/441,008

(22) PCT Filed: Sep. 12, 2007
(86) PCT No.: PCT/EP07/59592

§ 371 Date: Mar. 12, 2009

(30) Foreign Application Priority Data
Sep. 13, 2006 (US) 60844072

(51) Int. Cl. H04L 12/28

(52) U.S. Cl. 370/254

(57) ABSTRACT

The aim of the present invention is a method to achieve the customization of the communication network of a multicore communication system. This goal is achieved thanks to a method to design a multicore communication system, said communication system comprising a communication network having a plurality of switches and several elements communicating through the communication network, said method comprising the steps of: a) defining the communication network topology, comprising a number of switches, the architecture of said switches and the interconnection between said switches, b) defining routes to communicate among the elements through the switches according to the application running on the system, c) marking the input-to-output connections used within the switches traversed by these routes, d) removing all or part of the electronic components related to the non-marked connections.

### INTRODUCTION

A multicore computation system consists typically of a set of hardware blocks interconnected by a communication system. With respect to the information that has to be exchanged within such a device, the hardware blocks can behave as senders, as receivers, or both. Communication systems can be based on packets (packet-switched communication systems) or circuits. In the case of packet-based communication, the information that is to be sent from the senders to the receivers is segmented into multiple smaller units called packets. For circuit-based communication, a circuit is established between the sender and receiver units and data is transmitted on it. A communication system can be composed of switches, interface units, and links. The switches are sub modules of the communication system that route the data from the sender to the receiver, and are also known as routers. The switches and the interconnection between them are collectively referred to as the communication network of the system.

### BACKGROUND ART

If the hardware devices to be interconnected do not natively support packet-based communication, the segmentation/reassembly of information into packets is normally performed by the network interface units. The physical delivery of packets occurs over the links. Such a general communication system can be used to interconnect several electronic devices together or to connect the various onchip components present inside an electronic device.

Each switch in the network receives data from senders (through the interface units) or from other switches, and in turn sends the data to other switches or to the receivers. The communication can be either packet-based or circuit-based. Switches can optionally have buffering at the input ports, output ports or at both points. To route data from the input to the output ports, a crossbar matrix and one or more arbiters are utilized. The crossbar matrix is a device which provides connectivity between its inputs and its outputs, and several implementations can be envisioned: for example, the use of multiplexers, the direct use of cross-points in a grid, etc. A crossbar matrix can also be implemented as a hierarchical combination of several smaller crossbar matrices. The arbiters are used to grant or deny access to the resources within the crossbar matrix, for example by handling contention between different input ports which are trying to communicate with the same output port.

In U.S. Pat. No. 6,880,133, a method to remove multiplexers and repeaters for buses is presented. In the work, the bus is optimized by eliminating individual signaling wires based upon whether a core connected to the multiplexed bus interconnect transmits or receives signals. Unlike the signal optimization carried out in that work, we consider a routing-based optimization of interconnect hardware.

### BRIEF DESCRIPTION OF THE INVENTION

The aim of the present invention is a method to achieve the customization of above mentioned communication network. The method to route data in the network can be either static or dynamic in nature. In the case of static routing, the paths used for routing the data from senders to receivers are obtained at design time, based on the application characteristics. In the case of dynamic (also often called adaptive) routing, the routes or paths for the data are obtained dynamically, based on the dynamic knowledge of the network traffic. In the present invention, we target the optimization of systems that utilize static routing.

This goal is achieved thanks to a method to design a multicore communication system, said communication system comprising a communication network having a plurality of switches and several elements communicating through the communication network, said method comprising the steps of:
a. defining the communication network topology, comprising a number of switches, the architecture of said switches and the interconnection between said switches,
b. defining routes to communicate among the elements through the switches according to the application running on the system,
c. marking the input-to-output connections used within the switches traversed by these routes,
d. removing all or part of the electronic components related to the non-marked connections.

### BRIEF DESCRIPTION OF THE FIGURES

The present invention will be better understood thanks to the attached figures in which:

FIG. 1 illustrates a typical communication system,

FIG. 2 illustrates the general architecture of a switch,

FIG. 3 illustrates one specific embodiment of the hardware reduction process,

FIG. 4 illustrates the switch before and after the optimization process,

FIGS. 5a and 5b illustrate two examples of communication networks that can be optimized by our invention.

### DETAILED DESCRIPTION OF THE INVENTION

In FIG. 1, the elements A1, A2, A3 and A4 are active elements processing data, i.e. receiving and/or sending data to other elements. In a communication system, data is first passed through an interface (B1 to B4) attached to each active element before being transferred through the communication network. The communication network is formed by a plurality of switches C1 to C4 that are connected together according a predefined configuration (also called topology) by links (such as D). Data needing to be transferred e.g. from the element A1 to the element A4 first traverses the interface of A1 (i.e. B1) and then the switches C1, C2 and C4 according to this example, before reaching the interface of A4 (i.e. B4). Another alternative is to transfer the data via the switches C1, C3 and C4 instead. The sequence of switches to traverse is called route. Routes must be established if the application running on the system requires them, e.g. if A1 is a processor and A4 is a memory, and A1 needs to retrieve data from A4. Depending on the application, routes may not be needed among every pair of elements.

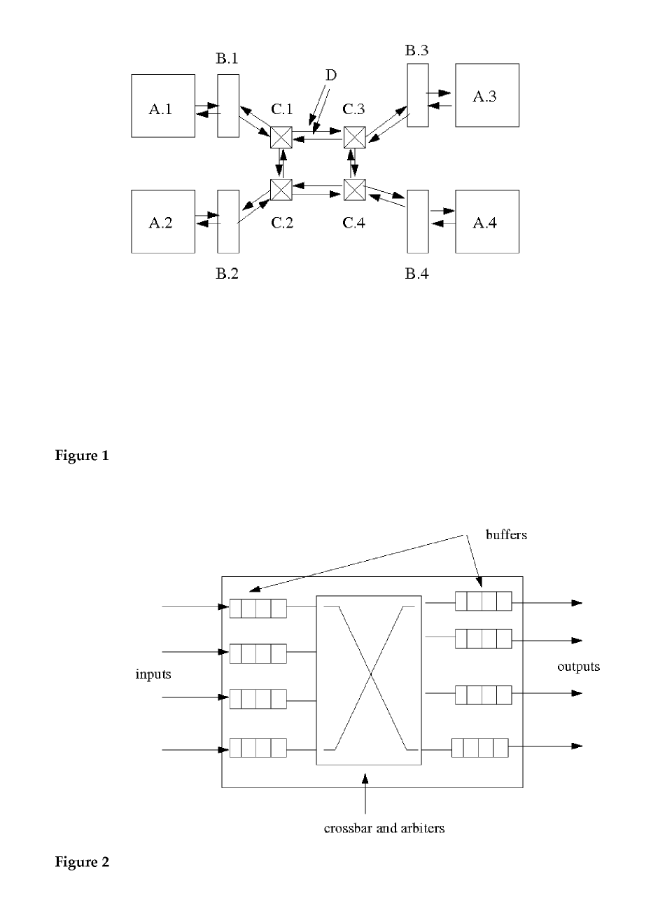

FIG. 2 illustrates a standard switch having four inputs and four outputs. The crossbar module allows the connection of a given input to a given output. In this example, inputs and outputs have buffers in case that a given path is currently in use by another active element.

### Basic Method to Reduce Switch Hardware

The communication network topology and the set of routes to be used for the different communication streams are pre-defined for the proposed first loop of the method. The network topology comprises a set of switches, the connectivity between them and their architecture. The number of input and output ports of a switch, amount of buffering and the crossbar implementation are defined by the switch architecture.

The topology of the communication system, i.e. the number of switches, the size of the switches (input and output ports) and the interconnections between the switches, is predefined. As a second step, the routes for the communication between the elements of the system are also defined, based on the application communication characteristics.

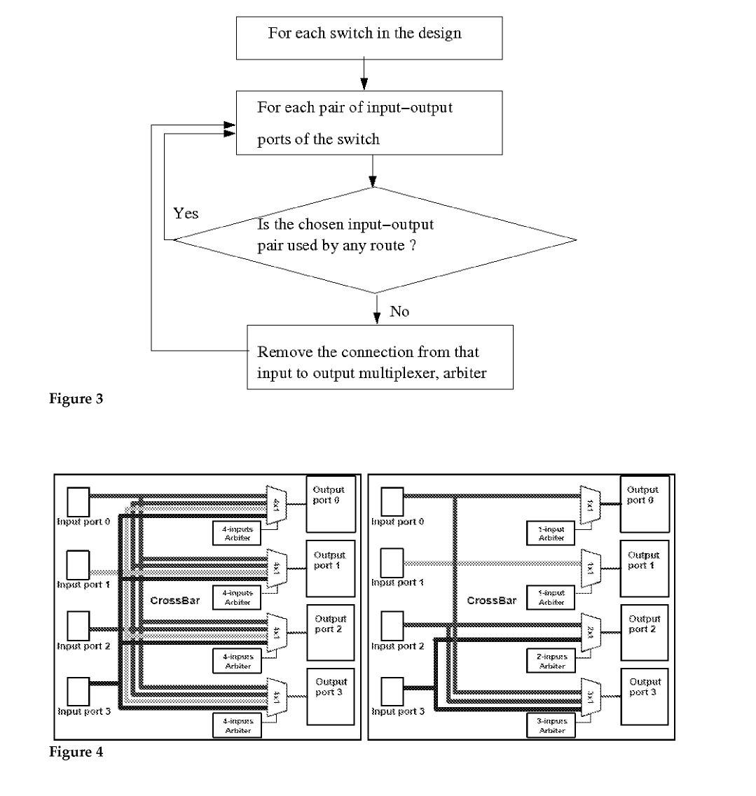

From the specifications, the method presented in FIG. 3 is executed. In this method, one or more of the switches in the design are considered, one at a time. For a chosen switch, each input-to-output port pair is considered. Then, it is checked to see whether any of the defined routes utilize the input to output port connection for transferring information. If the input-output pair is not used by any of the routes, then the connection between them in the crossbar matrix and the associated control circuit in the arbiter is removed. This results in removing the electronic components forming the input-output pair. After applying the method, only those input-output port pairs that are used by any route (or path) from senders to receivers are connected together inside the switch crossbar. The arbiters also only have that logic which is required to arbitrate these connections.

### Example 1

As an example, let us consider the set of input-to-output connections that are required at a particular switch (a 4×4 switch) of a communication system (refer to Table 1), which are obtained from the routing paths. In the table, the presence of a cross signifies that the input-to-output connection in the switch crossbar is used by at least one sender-to-receiver path. In FIG. 4 (left), we present a traditional architecture for this switch, where all the input ports are connected to all the output ports of the switch. In FIG. 4 (right), we present the switch architecture obtained by the proposed method, where the crossbar matrix and arbiters are customized to match the required input-to-output connections of the designed routes. The switch customization, in this example, leads to a 56.25% reduction in the input-to-output connections of the switch thus reducing the electronic components in the same range.

TABLE 1
switch routing table example.

| | Input port 0 | Input port 1 | Input port 2 | Input port 3 |
|---|---|---|---|---|
| Output port 0 | X | | | |
| Output port 1 | | X | | |
| Output port 2 | | | X | X |
| Output port 3 | X | | X | X |

Crosses mark the input-to-output connections in the switch crossbar which are used by at least one sender-to-receiver pair.

### Evaluation of Alternate Routing Paths

In this sub-section we present an extension of the method presented in the previous sub-section to evaluate alternate sets of routing paths. To achieve this, the method of FIG. 3 needs to be iterated, with each iteration having a different routing path for at least one of the traffic flows in the communication system. For each set of routing paths considered, the design metrics of the resulting optimized network are stored in a table. The design metrics are usually the gate count (or area) of the communication network components, the power consumption and delay of the network components. The designer can choose one or a combination of these metrics to be considered as objectives for optimization, and can also impose constraints on these metrics. As an example, the designer can choose to minimize the area of the communication network design, satisfying pre-defined constraints on power consumption and delay.

From the table of all sets of routing paths considered, the set that minimizes the design objective, satisfying all the design constraints can then be chosen by the designer.

### Evaluation of Alternate Network Topologies

The number of switches, their sizes and the interconnection between (together comprising the network topology), which are inputs to the procedure in FIG. 3, can also be iteratively changed. The method in FIG. 3 can be repeated for each iteration of the network topology, for a predefined set of routing paths. The resulting communication network design metrics can be tabulated. From the different solutions, the one that minimizes the objectives, satisfying the design constraints can be chosen by the designer.

When the network topology is varied, for each topology point, the set of routing paths can also be varied. In this case, the design metrics for all different topologies and routing paths can be tabulated and the most efficient design point can be chosen.

### Method to Increase the Operating Speed of a Communication System

The operating speed, or frequency, of the communication system should be maximized to improve performance. The operating speed of the communication system could be limited by that of one of the switches in the design. Therefore, it is desirable to be able to set a lower bound for the operating speed of the switches in the system.

As the number of input-to-output connections within the switch crossbar increases, the operating speed of the switch decreases, since the amount of logic to be traversed inside the switch (commonly called critical path) increases.

Given the number of input ports which need to be connected to each output port in the switch crossbar, the maximum frequency that can be supported by the switch can be obtained before designing the complete network. This direct relationship between the maximum operating frequency of the switch and the maximum number of connections to a single output can be exploited for the design of the overall communication system. If the operating frequency of the whole communication system is limited by the maximum operating system of one or more switches, it is possible to apply optimization techniques to increase the performance of the whole communication system.

We propose two different strategies to apply such optimizations:

### 1) Frequency-Driven Route Assignment:

Let us consider a scenario where the topology of the communication system is already designed and only the routes for the packets need to be obtained. The routes can be chosen so that the connectivity required within the switch crossbars is small, and the desired high frequency operation is achieved. In one possible implementation, when there are two or more possible routes between a sender/receiver pair, a path that results in the smallest maximum crossbar and arbiter size (across all the switches in the path) can be chosen.

### 2) Frequency-Driven Topology Design and Route Assignment:

Let us consider the scenario where the network topology and the routing paths need to be designed, such that a specified frequency of operation is to be achieved.

In this case, the topology and route selection processes can be constrained in order to limit the input-to-output connectivity within the switches, so that the desired high frequency operation is achieved.

### Extension of the Methods to Different Switch Crossbar Implementations

As noted earlier, the crossbars and arbiters of the switches can be implemented in several different ways. As an example, several possible crossbar implementations such as the use of cross-points, of a Banyan network, of a Batcher Banyan network are illustrated. Our routing-based hardware reduction is applicable to optimize such different implementations. In one possible implementation, the crossbar is made of multiple cross-points. In such a case, the connectivity between the cross-points can be optimized based on the chosen routes. In another possible implementation, the crossbar matrix can be composed of several smaller crossbar matrices. In such a scenario, the smaller crossbars can also be optimized.

The number of stages of smaller crossbars, the size of the smaller crossbars, the connectivity between the smaller crossbars can be optimized based on the routes.

### Application of the Method to Size Buffers and Links

The hardware customization method can be applied to set the size of the buffers in the switches and the bandwidth of operation of the links. Whenever the number of connections to the multiplexers and arbiters are reduced, the amount of buffering available for the input and/or output port can be reduced proportionally. Similarly, the bandwidth of the link from an output port of the switch can be reduced proportionally to the amount of hardware reduction achieved for that output port. Such bandwidth reduction can be achieved, for example, by reducing the frequency of operation of the links or the number of parallel bit-lines of the link.

### Case Study Application to On-Chip Communication Networks

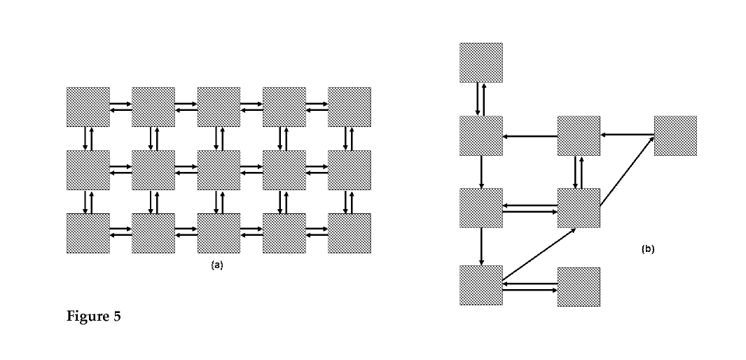

In this section, we apply the proposed ideas to a packet-switched on-chip communication system. As an example, we present two different communication network topologies; the first is regular, a so-called 5×3 mesh (FIG. 5(a)), while the second is irregular, and was manually generated in a custom way (FIG. 5(b)). We use such different topologies to show the generality of the proposed optimization methods.

The topologies can be used to implement the communication system of a multicore computation system including thirty sender/receiver elements. According to the application to be run on this system, only some routes need to be established across the topologies; we assume one specific such application, which is omitted for the sake of brevity. Table 2 shows the total area of the switches for the two topologies, for a non optimized design and for the design where the proposed switch hardware optimization technique is applied. The use of the switch customization technique leads to a large reduction (an average of 30.63%) in the total switch area of the design. Since the switch crossbar and arbiter are largely combinational blocks, even larger savings are noticeable when considering the combinational part of the switch area alone.

TABLE 2
total area of the switches for the designs.

| | | Total | Total | | | | |
|---|---|---|---|---|---|---|---|
| | Total switch | switch | switch | Combinational | Combinational | Combinational | |
| | area | area | area | switch area | switch area | switch area | #I-to-O link |
| Topology | unoptimized | optimized | reduction | unoptimized | optimized | reduction | reduction |
| 5 × 3 mesh | 0.73 mm² | 0.51 mm² | 30.14% | 0.32 mm² | 0.16 mm² | 50.63% | 69.83% |
| topology | | | | | | | |
| custom | 0.45 mm² | 0.31 mm² | 31.11% | 0.22 mm² | 0.09 mm² | 59.09% | 66.38% |
| topology | | | | | | | |

1. A method to design a multicore communication system, said communication system comprising a packet-based communication network having a plurality of switches and several elements communicating through the communication network, said method comprising the steps of:
a. defining a communication network topology, comprising a number of at least two switches;
b. defining physical connectivity among the outputs of some switches and the inputs of some switches according to the network topology;
c. defining a switch architecture to transfer information among its input and output ports depending on information attached to incoming packets:
d. defining routes to communicate among the elements through the switches according to the application running on the system;
e. marking the input-to-output connections used within the switches traversed by these routes; and
f. removing all or part of the electronic components related to the non-marked connections.

2. The method of claim 1, further comprising the steps of:
g. defining a plurality of sets of communication network routes to communicate from elements to other elements through the communication network;
h. executing the steps e to f; and
i. storing each set of communication network routes and the resulting communication network metrics.

3. The method of claim 2, further comprising the steps of:
j. choosing one set of communication network routes based on the stored metrics and on predefined design constraints.

4. The method of claim 1, further comprising the steps of:
defining a plurality of communication network topologies;
executing the steps d to f; and
storing each communication network topology and the resulting communication network metrics.

5. The method of claim 4, further comprising the steps of:
choosing one communication network topology based on the stored metrics and on predefined design constraints.

6. The method of claim 3, further comprising the steps of:
defining a plurality of communication network topologies;
executing the steps d to j; and
storing each communication network topology and set of routes and the resulting communication network metrics.

7. The method of claim 6, further comprising the steps of:
choosing one communication network topology and set of routes based on the stored metrics and on predefined design constraints.

8. The method of claim 1, wherein the switches comprise input and/or output buffers which are taken into account in the removal process.

9. The method of claim 1, wherein at least some of the switches are based on multiplexers.

10. The method of claim 1, wherein at least some of the switches are based on crosspoint matrices.

11. The method of claim 1, wherein at least some of the switches are based on a hierarchy of crossbars.
